(19) United States
(12) Patent Application Publication
(10) Pub. No.: US 2003/0219626 A1
(43) Pub. Date: Nov. 27, 2003

(54) Material and method for improved heat dissipation and mechanical hardness for magnetic recording transducers and other electronic devices

(76) Inventor: Charles Partee, Lyons, CO (US)

Correspondence Address: ECKERT SEAMANS CHERIN & MELLOTT, 600 GRANT STREET, 44TH FLOOR, PITTSBURGH, PA, 15219

(21) Appl. No.: 10/337,751

(22) Filed: Jan. 7, 2003

Related U.S. Application Data
(60) Provisional application No. 60/372,241, filed on Apr. 12, 2002.
(60) Provisional application No. 60/345,511, filed on Jan. 7, 2002.

(51) Int. Cl. G11B 5/66

(52) U.S. Cl. 428/694 R

(57) ABSTRACT

The invention discloses a process for creating an improved surface that serves as a base or underlayer, planarization layer, read layer, write layer and encapsulation material for use in generic devices that require superior heat dissipation, mechanical hardness and surface smoothness. More particularly, the invention discloses an improved material, a polymer precursor to ceramic, for use in such devices, and methods for making magnetic recording transducers, semiconductors and microelectronic mechanical system transducers using this material. The material provides improved heat dissipation, mechanical hardness, and surface smoothness. The invention also discloses devices made with such material by the disclosed methods.

### CROSS REFERENCE TO RELATED APPLICATION

This application claims priority under 35 USC §119 to provisional application serial No. 60/372,241, filed Apr. 12, 2002, and provisional application serial No. 60/345,511, filed Jan. 7, 2002.

### FIELD OF THE INVENTION

The present invention discloses a process for creating an improved surface that can serve as a base or underlayer, a planarization layer, a spacer layer, a dielectric layer, an adhesive layer, and an encapsulation layer in magnetic recording head devices. More particularly, the present invention relates generally to the design and manufacture of magnetic recording read/write transducers having one or more of these layers, using a polymer precursor to ceramic that provides improved heat transfer, mechanical hardness, smoothness, performance and longevity. The material can also be used to improve static discharge protection. This invention also has applicability to semiconductors, MEMs and other electronic devices which, through the use of the materials of this invention in one or more of these layers, can be improved.

### BACKGROUND OF THE INVENTION

The information storage industry is driven by market demands to increase continually the capacity and performance of disk drives for storing information. Driven by and reflecting this demand, the amount of storage capacity in a typical disk drive is doubling every year. To meet this capacity demand without increasing costs by adding more disks and heads, disk and tape drive suppliers are continually increasing the areal density of the stored information. Read and write transducer design and processing are key technologies wherein continuous improvement is required to achieve these capacity increases.

The inductive write element includes a coil layer embedded in an insulation stack, the insulation stack being located between the first and second pole piece layers. A gap between the first and second pole piece layers is formed by a gap layer at the air-bearing surface (ABS) of the write head. The pole pieces are connected at a back gap. A rapidly changing current, which corresponds to coded data, is conducted through the coil layer which produces magnetic fields in the pole pieces. The magnetic fields fringe across the gap at the ABS in proximity to a moving magnetic medium such as a disk or tape. The fringing magnetic fields set the magnetic orientation at given locations on the disk or tape. The varying orientations correspond to the coded data. In this manner, data is written on the magnetic storage medium.

The read element that reads the data from the disk is sandwiched between two shields but isolated from them by a read gap on each side. During a read operation, the read element flies in proximity to the disk so that the read element senses the magnetic orientation of the given disk location. Various read-element technologies are employed in modem disk and tape drives, such as Anisotropic Magnetoresistive, Giant Magnetoresistive (GMR), and Current-Perpendicular-to-Plane GMR (CPP-GMR) heads. They are generally similar in usage in that the resistance of the read element changes in response to an external magnetic field, such as the field from the encoded data on the disk. In each of these methods, as well as other methods not described here, a sense current is passed through the read element and attached electronics are used to sense the change in resistance. Generally, it is desirable to operate at a higher current because that generally produces more signal amplitude.

In disk drive recording heads, the read element and the write element are typically fabricated together in a merged device on a wafer, such as ceramic AlTiC. They are separated from the ceramic by a dielectric underlayer, such as alumina. Further, after fabrication, they are protected from outside damage by encapsulating the entire device in a dielectric, such as alumina. In tape heads, a merged device can be used or a separate read device and write element can be fabricated. In this case, the read head and the write head are both individually processed on a ceramic wafer and protected by the underlayer and encapsulation layer described above. An additional layer (referred to herein as a ‘wear cap’ or ‘capping substrate’), generally but not always made from the same material as the substrate, is bonded to the tape head on the side opposite the substrate to provide for tape bearing surface (TBS) fabrication and to protect the relatively soft reader and writer elements from wear since the moving media is generally in contact with the tape recording head elements.

Use of conventional materials in the production of MRTs and other devices can cause various types of problems. For example, during definition of the ABS or TBS and the final geometry of the read/write transducer, several mechanical or chemo-mechanical polishing (“lapping”) processes can be used. This lapping can remove material at a differential rate. The pole material is relatively soft and tends to erode faster than the neighboring dielectric. The dielectric is softer than the ceramic substrate the device is fabricated on, so it erodes faster than the substrate. Tape heads can suffer from an additional source of erosion in this area during operation as the tape moves in close proximity to the tape head. Contact between the moving tape and the tape head during writing and reading of data can further erode the softer layers. This erosion leads to increasing recession of the poles over the life of the tape head, which is undesirable because it increases the distance between the disk or tape and the read/write transducer, in turn leading to reduced performance. In tape heads, the increasing distance over the life of the product also leads to reduced reliability in the field.

The read sense current used in the read element increases the temperature of the element substantially over that of the surrounding environment. The heat is dissipated through neighboring layers (the gap layers, the shields, the underlayer) and eventually into the surrounding air. This heat shortens the lifetime (for example, through electromigration) and reduces the performance of the sensor and limits how much current can be passed through it. The heating also causes stress in the read element as the neighboring materials may expand at different rates. In some disk drives, the read sense current is often left on whenever the particular head is active, even when it is writing instead of reading data.

Similarly, the write current used in the write element increases the temperature of the write coil. This heat is dissipated through neighboring layers. This heating effect causes stress in the write element as the neighboring materials expand at different rates. This stress can cause residual magnetization to remain in the shields and write poles after the write operation is finished. This residual magnetization can then relax to a net zero magnetization at a later time and produce a noise spike (“read after write noise” or “popcorn noise”) during a later read operation. In addition, the differential expansion, if any, of the pole material compared to the neighboring materials can cause the pole tip to protrude outward from the slider body. This pole-tip-protrusion can lead to contact with the moving magnetic medium in proximity to it. This can cause damage to the recording layer and lead to loss of data. In addition, the contact with the disk can cause additional heating due to the contact energy.

There is a continued need for improved materials, that can be deposited using methods and processes that are readily available, which can provide superior heat dissipation, mechanical hardness, electrostatic discharge protection and surface smoothness, for use in the above described devices.

### SUMMARY OF THE INVENTION

Accordingly, the present invention solves the above needs through the use of a polymer precursor to ceramic. Unlike conventional methods and materials for constructing the base or underlayer, read and write gaps, planarization layers, spacer layers, and adhesive and encapsulation layers for magnetic recording transducers, polymer precursors to ceramic can be used in these layers, and converted to ceramic to provide the desired properties.

In a preferred embodiment, the polymer precursors to ceramic have the chemical formula [CR]ₙ, more fully defined below.

These polymer precursors offer a surface having increased hardness and/or thermal conductivity. The ceramic can be processed to provide exceptional surface smoothness, with or without subsequent polishing operations. Use of this material and the method of applying the material also result in a more efficient and improved ease of manufacturing in some steps, as is clear to those skilled in the art. For example, for the base layer of a magnetic recording head, a dielectric that is spun on and then baked, having sufficient smoothness for subsequent processing, reduces the amount of processing required as compared to a dielectric layer formed from conventional materials, which requires a lengthy vacuum sputtering process followed by a separate chemomechanical planarization step.

Further, the ceramic can provide improved static discharge protection since the electrical conductivity of the ceramic used in the present invention can be controlled to enhance charge dissipation.

Further, the ceramic can be used as an adhesive layer between the device and the ‘wear cap’ for a tape head.

When applied to the method for making magnetic recording transducers, the increased thermal conductivity of the ceramic extends the lifetime of the read sensor at higher currents which allows improved performance. The improved surface also reduces the heat buildup and associated deleterious effects in the write element. The mechanical hardness of these layers also improves the slider processing, decreasing pole tip recession and pole smearing. Used as an adhesive layer between the device and the wear cap in tape heads, the surface offers a strong bond, improved thermal conductivity and a harder surface compared to the epoxies currently used. These improvements can be used singly or jointly to good effect.

It is an object of the present invention, therefore, to provide a method for making a high-performance surface that must withstand challenge by a variety of deleterious conditions, and that has superior hardness, and thermal conductivity, and is more efficient to produce than current methods for such surfaces.

Another object of the present invention is to provide a method and material which can improve the performance and longevity of read/write sensors in several ways which can be used singly or jointly.

Another object of the present invention is to provide a material and method for depositing the material that will improve the heat conduction between a shield and a slider body.

Another object of the present invention is to provide a material and method for depositing the material that will improve the heat conduction between an MR sensor and shields.

Another object of the present invention is to provide a material and method for depositing the material that will improve the heat conduction between a write element and neighboring structures that can act as heat sinks, including read element shields and a slider body.

Another object of the present invention is to provide a material and method for depositing the material that will increase the mechanical hardness of the underlayer, read and write gap layers, and the encapsulation layer.

Another object of the present invention is to provide a material and methods for decreasing the roughness of the underlayer, the gap layers and the encapsulation layer.

Another aspect of the present invention is to provide the design for single or for multiple magnetic recording head assemblies.

These and other aspects of this invention will be obvious to one skilled in the art by reading the following description in conjunction with the accompanying drawings forming a part of this specification.

### BRIEF DESCRIPTION OF THE DRAWINGS

Before explaining the disclosed embodiment of the present invention in detail, it is to be understood that the invention is not limited in its application to the details of the particular arrangement shown, because the invention is capable of other embodiments. Also, the terminology used herein is for the purpose of description and not of limitation.

FIG. 1 is a labeled view from the air bearing surface of an exemplary magnetic recording transducer suitable for use in a disk drive.

FIG. 2 is a labeled cross-sectional view of an exemplary magnetic recording transducer suitable for use in a disk drive.

FIG. 3 is a labeled cross-sectional view of an exemplary magnetic recording read transducer suitable for use in a tape drive that uses separate read and write elements.

FIG. 4 is a labeled cross-sectional view of an exemplary magnetic recording write transducer suitable for use in a tape drive that uses separate read and write elements.

### DESCRIPTION OF THE PREFERRED EMBODIMENT

In accordance with the principles of the present invention, certain layers in magnetic recording transducers and other electronic devices such as semiconductors and MEMs devices can be formed from polymer precursors to ceramic (PPTC). In a preferred embodiment, the underlayer, read and write gap layers, planarization layers, and encapsulation are all made from PPTC, but these layers can be used independently or in combination depending on the device requirements. As will be understood by one skilled in the art, these layers may be called by different names in other electronic devices, but the methods and materials described herein are equally applicable to use in other devices where the layers provide a similar function and/or purpose.

As used herein, the term “bottom surface” will denote the layer over which the polymer precursor is to be applied; this will depend on which layer (underlayer, encapsulation, read, write, and the like) is to be formed from the polymer precursor.

Also in a preferred embodiment, the PPTC is applied to the device in a fashion similar to photoresist application methods familiar to those skilled in the art (spin-on), but other methods, including, but not limited to, spraying, dipping or wiping the device or substrate can be used. In each case, the PPTC is converted to ceramic using any of several methods such as baking in an inert atmosphere, such as an argon atmosphere, at temperatures ranging from about 20° C. to about 1800° C. for time periods from 5 min to 60 hours. Preferably, for the underlayer, and in devices such as MEMs and semiconductors, the baking is carried out a temperature of about 300° C.-600° C., more preferably 350° to 450° C., for about 1-2 hours. Other methods such as exposure to radiation, such as IR or UV radiation, exposure to a plasma, such as a hydrogen plasma, or baking under an active atmosphere are also suitable.

The polymer precursor can be converted to different ceramics, such SiC, SiN, or diamond-like carbon or diamond, depending on the polymer precursor used and the properties desired, without changing the intent of this present invention.

As used herein, the term “polymer precursor to ceramic” refers to the use of organo-metallic polymer precursors that can be used to make ceramics, as that term is understood in the art.

In a preferred embodiment, the term “polymer precursor to ceramic” refers to polymers described in U.S. Pat. No. 5,516,884, expressly incorporated herein by reference. These polymers are in liquid form and are represented by the formula

[CR]ₙ

where R is the same or different and is selected from the group consisting of hydrogen, a saturated linear or branched—chain hydrocarbon containing 1-30 carbon atoms, and an unsaturated ring hydrocarbon containing 5 to 14 carbon atoms in the ring, each in unsubstituted or substituted form. R can also be a halogen, a Group 4 metal, and a Group 13 through Group 16 element. The lower limit for n is about 8. Where substituted, the substituent groups can be a halogen, nitro, cyano, alkoxy, carboxy, aryl, hydroxy, heterocyclic alkyl, or heterocyclic aryl groups; a halogen, a Group 4 metal, and a Group 13 through Group 16 element. The polymer comprises tetrahedrally hybridized carbon atoms linked to each other by three carbon-carbon single bonds into a three-dimensional continuous random network backbone, with one R group linked to each of said carbon atoms.

The term “polymer precursor to ceramic” thus embraces both silicon and non-silicon based polymer precursors which, when heated at the appropriate temperature, are converted to a ceramic material, as that term is understood in the art. Examples of preferred polymers of the above formula include [SiC]ₙ where n is greater than 20 and [CH]ₙ where n is greater than 8.

The hardness of diamond-like carbon varies substantially depending on its crystal structure, from as low as 40 kg/mm² up to 10,000 kg/mm² (the latter value for crystalline diamond). One of the beneficial features of the diamond-like carbon produced by this polymer precursor is that the hardness can be controlled within certain ranges for ease in future processing. For example, if a particular diamond-like carbon surface needs to be lapped smoother than as-deposited, for example in formation of a read gap, then the hardness of that particular layer can be controlled so that it is more readily lappable by conventional means. Hardness is controlled through the conversion process, with increasing hardness provided with the use of higher temperatures and a longer conversion time. In this preferred embodiment, the hardness of a layer, such as an encapsulation layer, that did not need to be lapped would be about 1500-10,000 kg/mm² whereas a layer that did require lapping would be about 800-1200 kg/mm². This is as compared to conventional materials, which typically have a hardness between 50-500 kg/mm². However, there is a trade-off to having ceramics of lesser hardness, as the processing conditions for ceramics of lower hardness can currently also result in lower values for thermal conductivity.

Similarly, the thermal conductivity of the material is dependent on the polymer and the conversion method used. Typical values range from about 100 J/m °K up to 2000 J/m °K. In the preferred embodiment, the thermal conductivities greater than about 800 J/m °K are used. This is as compared to conventional materials, such as alumina, which has a thermal conductivity in the range of 20-50 J/m °K, typically 36 J/m°K.

The roughness of the converted polymer can be also be controlled by processing means, such as controlling the spinning speed, length of spin time, and use of bottom surface pretreatments such as prewetting the surface with an appropriate solvent, such as tetrohydrofuran, seeding the surface with seed crystals, such as diamond seed crystals, or controlled roughening of the bottom surface, such as abrading the surface with a lapping slurry. Typically, a roughness of less than 5 nm Rₐ is desirable for baselayers. For read gaps, roughnesses of 0.5 nm Rₐ and smoother are required for the latest sensors. A subsequent chemomechanical polishing step can be used to achieve this roughness. This is compared with conventional materials, in which a roughness between 10 to 2000 nm can be observed. The conventional materials always require a subsequent smoothing step, such as chemomechanical polishing, to meet the required smoothness described above.

As discussed above, the electrical conductivity of the ceramic used in the present invention can be controlled to enhance charge dissipation. In an additional preferred embodiment, the properties of the polymer precursor are chosen (for example, through the use of boron or phosphorous atoms attached to the backbone) to be slightly conductive, in the range 10⁸ to 10¹⁰ ohm-cms so that any static charge from tribo-charging processes or other charge transfer processes, has a larger possibility of being dissipated without harming the sensitive transducer elements.

In a preferred embodiment for tape heads, the PPTC can be used as an adhesive layer because it bonds very strongly with the substrate and wear cap materials. The advantage to this approach is not just the strong bond between the device and the wear cap, but that the bond material is thermally conductive and very hard, in opposition to the softer, thermally resistive epoxies now used. A preferred ceramic for use in the adhesive layer is diamond-like carbon.

The substrate is prepared using standard methods and materials known in the art, and the PPTC is applied and converted to ceramic by any of the above described methods. Additional suitable methods of conversion include those described in U.S. Pat. No. 5,516,884. In a preferred embodiment of forming the underlayer, the PPTC is spun-on in a manner similar to photoresist and converted by baking in an argon atmosphere at temperatures between 300° C. and 600° C., more preferably 350° to 450° C., for 2 hours. The thickness of the underlayer ranges between 1 and 6 microns. Different spin speeds, polymer viscosities, and surface preparations can be used to obtain layers of varying thicknesses The ceramic can be polished using chemomechanical planarization (CMP) or mechanical planarization (MP) depending on the device requirements. The shields may be deposited and patterned in the conventional way. The thickness of the shields in this embodiment is between 1 and 3 microns.

In a preferred embodiment, the PPTC is spun-on, converted, and then lapped back using CMP or MP to planarize the shields and provide a thermally conductive path around them. However, the conventional process for shield planarization, in which a soft dielectric such as Al₂O₃ is deposited and chemomechanically lapped back to expose the shields can be used without substantial detrimental effect since the areas where the Al₂O₃ will reside is not in the direct heat dissipation path. However, where the Al₂O₃ is exposed on the ABS or TBS, it may recede as it does in the conventional method.

The PPTC can be spun-on and converted in a similar fashion as previously described to form the first read gap layer. A typical read gap thickness in current state of the art for disk heads is between 30 to 70 nm, with a preferred embodiment being in the range of 40 nm to 55 nm. A typical read gap thickness for tape heads is between 70 to 200 nm, with a preferred embodiment being in the range of 70 to 120 nm. Due to requirements of preserving the first shield material, the temperature of the conversion step of the read gap layer generally must be between 20 to 300° C. In one embodiment, a preferred range is 150 to 250° C. In an additional embodiment, the preferred conversion range is 150 to 200° C. In an additional embodiment, a radiation source, such as a UV source, is used for the conversion of the read gap to avoid overheating the shields. The read sensor and conducting leads are formed in the typical fashion. To form the second read gap, the PPTC is again spun on and converted to ceramic. Due to requirements of preserving the sensor material, the temperature of the conversion step often must be lower than for the conversion of the first read gap layer or underlayer. For AMR sensors, such as currently generally used in tape heads, the preferred temperature is between 20 to 200° C., with one preferred embodiment between 150 to 200° C. For GMR-based sensors, such as currently generally used in disk heads, the preferred temperature range is between 20 to 110° C. In additional preferred embodiment, the temperature range is 40 to 90° C. Due to the lower temperatures required, in the most preferred embodiment, a radiation source, such as a UV source, is used for the conversion. For “CPP-MR” sensors, the read gaps would typically be formed of a conductive metal and not of the PPTC material.

For any layer deposited subsequent to the sensor deposition, such as, in the conventional design used as exemplary here, the second read gap, write gap, and encapsulation layers, the conversion is performed such that the read sensor temperature remains in the range 20 to 110° C. In a preferred embodiment, the read sensor temperature remains in the range 40 to 90° C.

The second read shield is then formed in the standard way, known to one skilled in the art, and can be planarized in the same manner as the first shield. The write gap is then formed in a similar manner as the read gaps, as described above. The write gap thickness in current tape head designs is between 150 to 400 nm; in disk heads the write gap thickness is between 100 to 250 nm. In the design used as exemplary in this disclosure, the write gap is formed after the read sensor, so the conversion is performed such that the read sensor temperature remains in the range 20to 110° C. In a preferred embodiment, the read sensor temperature is in the range 40 to 90° C. during the conversion of the write gap. The remainder of the write element is then formed in the typical way, known to one skilled in the art. After the write element is completed and the electrical interconnects are fabricated, the PPTC encapsulation layer can be spun-on in the method of the present invention as described above. In some designs, the encapsulation may require two or more iterations to achieve the desired thickness, such as 2-20 microns. In a preferred embodiment, the conversion is performed such that the read sensor temperature remains in the range 20 to 110° C. In a preferred embodiment, the read sensor temperature is in the range 40 to 90° C. during the conversion of the encapsulation. In the most preferred embodiment, a radiation source, such as a UV source, is used for the conversion. The encapsulation layer is polished back to allow contact to the electrical interconnects to the read and write transducers.

In an embodiment specific to tape heads, after the encapsulation layer is converted to ceramic, it is polished, if necessary, to provide a flat surface for the bonding of the protective wear cap. In this embodiment, an adhesive layer of the PPTC is applied to the wear cap or to the top surface of the tape head and the two pieces are placed in contact. The thickness of the bondlayer is between 0.2 and 3 microns. In a preferred embodiment, the thickness is between 1 and 2 microns. The PPTC is then converted to ceramic. For AMR-based tape heads, one preferred temperature range is between 20 to 200° C., with an additional more preferred embodiment between 150 to 200° C. This conversion process bonds the wear cap tightly to the encapsulation. The PPTC and wear cap are chosen for their hardness and good mutual adhesion properties, such as polymer precursor to diamond and AlTiC wafer. They are also chosen for the suitability to be further processed to form a tape bearing surface. Depending on the outgassing characteristics of the PPTC, channels or holes are provided in the appropriate positions in the wear cap to accommodate the outgassing.

In another embodiment specific to tape heads, the wear cap can be formed entirely of one or more layers of the converted PPTC, applied repeatedly as described above as often as required to achieve the required thickness of the wear cap (such as 10 mils), without the bonding operation.

In another embodiment specific to tape heads, the PPTC could be formed on a sacrificial substrate, such as Si, that would be chemically or mechanically removed to leave the entire underlayer and wear cap composed of the converted PPTC

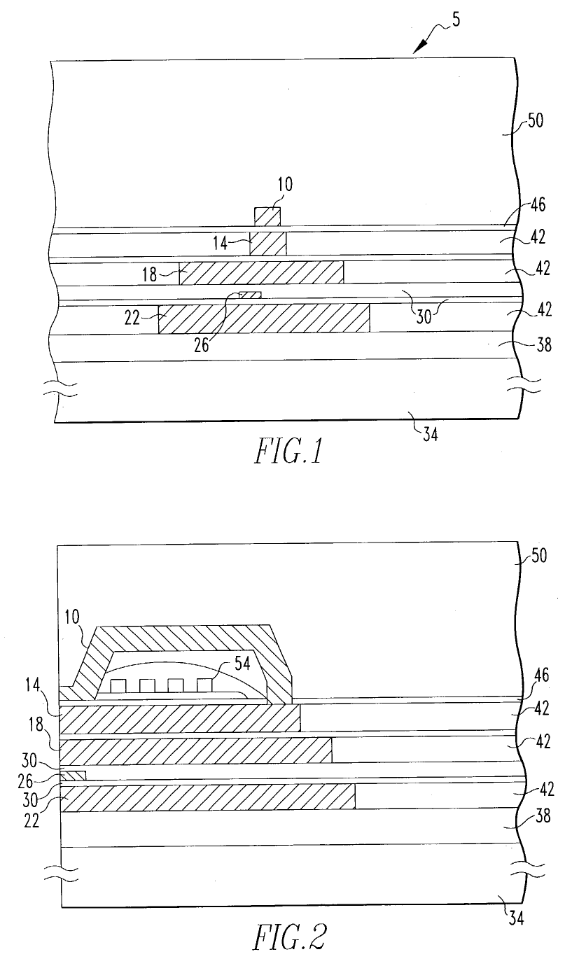

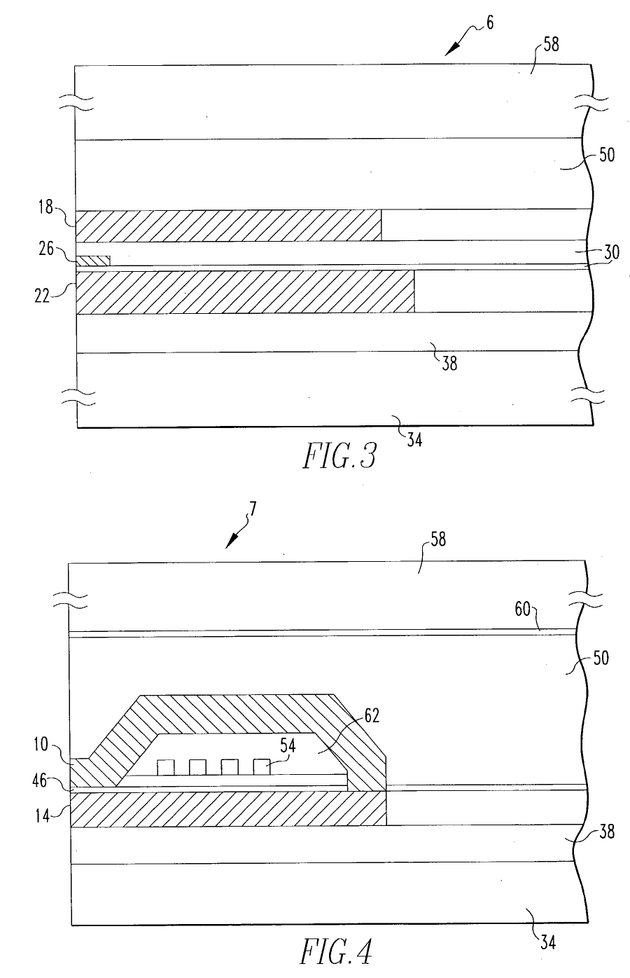

Referring now to the figures, FIGS. 1-4, FIG. 1 provides a labeled view from the air bearing surface of an exemplary magnetoresistive read/write head 5 suitable for use in a disk drive. FIG. 2 is a cross section of the read/write head, while FIGS. 3 and 4 refer to transducer having separate read 6 (FIG. 3) and write 7 (FIG. 4) elements. The read/write head 5 comprises a magnetic field sensor 26 to read the data and a magnetic field generator to write data on the disk. The magnetic field generator typically includes two poles, the top pole 10 and the bottom pole 14 that are separated by a write gap 46. A magnetic field is generated when poles 10 and 14 are excited by a current flowing in a coil formed by coil elements 54 shown in FIGS. 2 and 4. When write gap 46 is in proximity to the magnetic media, a magnetic field generated by poles 10 and 14 creates selected magnetic orientations in selected locations on the magnetic media.

The magnetic field sensor 26 (also shown in FIGS. 2 and 3) is positioned between two shield elements, the top shield 18 and the bottom shield 22. The sensor 26 is separated from the shield elements 18 and 22 by a layer or layers 30 referred to as the “read gap”.

A planarizing layer or layers 42, shown in FIGS. 2 and 4, is used to form an insulator upon which the write coils 54 are formed.

The read/write head 5 shown in FIGS. 1 and 2, or the separate read 6 and write 7 elements shown in FIGS. 3 and 4 are formed on a substrate 34 that comprises a ceramic, typically made of AlTiC, which is then coated with an underlayer 38, also referred to as a base layer. After fabrication, the read/write head 5 or separate read 6 and write 7 elements are further protected with an encapsulation layer 50. In the case of tape heads an additional layer referred to as a capping substrate 58 is used to protect the relatively soft reader and writer elements from wear, as described above. An adhesive layer 60 provides adherence of the capping substrate to the encapsulation layer.

Fabrication of the magnetic recording transducer is standard and known in the art, with the exception of application of the underlayer, planarization layer, read and write gaps and encapsulation layers as applied as described in the present invention.

Other similar head structures can be used (such as those described in U.S. Pat. Nos. 6,105,238, 6,081,408 and 6,278,591, expressly incorporated herein by reference), or a device wherein the order of fabrication of the writer and reader is reversed, with the PPTC materials and methods described herein.

### EXAMPLE

In an experiment to replace the current alumina baselayer with a layer of diamond-like carbon film, the [H-C]ₙ polymer was fabricated in the manner described in U.S. Pat. No. 5,516,884, where n was greater than 200. Using ultrasonic agitation, the polymer was dissolved in a solvent, tetrahydrofuran, at an approximate concentration of 1 g/ml. The polymer was aerosolized with compressed dry air and sprayed onto a 6 inch Al/TiC wafer, spinning at 1000 rpm, for 10 seconds. The rate of addition of the polymer in the spray was undetermined. After the spray operation was completed, the wafer was spun up to 2500 rpm for 5 minutes in order to improve thickness uniformity and partially evaporate the solvent. The wafer was then placed in a vacuum chamber for 2 hours to complete the solvent evaporation. The wafer was then baked in a nitrogen atmosphere at 400° C. for 2 hours. The ramp up rate was 1 C/min; the ramp down rate was uncontrolled.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A magnetic recording transducer comprising at least one layer formed from a polymer precursor to ceramic.

2. The transducer of claim 1, wherein said layer is selected from the group consisting of underlayer, planarization layer, read gap layer, write gap layer, adhesion layer and encapsulation layer.

3. The transducer of claim 1, wherein said layer is an underlayer.

4. The transducer of claim 1, wherein said layer is a planarization layer.

5. The transducer of claim 1, wherein said layer is an encapsulation layer.

6. The transducer of claim 1, wherein said layer is a first read gap layer.

7. The transducer of claim 1, wherein said layer is a second read gap layer.

8. The transducer of claim 1, wherein said layer is a write gap layer.

9. The transducer of claim 1, wherein said layer is an adhesion layer.

10. The transducer of claim 1, wherein said polymer precursor to ceramic is represented by the formula
[CR]ₙ
where R is the same or different and is selected from the group consisting of hydrogen, a saturated linear or branched-chain hydrocarbon containing 1-30 carbon atoms, an unsaturated ring hydrocarbon containing 5 to 14 carbon atoms in the ring, each of said ring carbon atoms in unsubstituted or substituted form, a halogen, a Group 4 metal, and a Group 13 through Group 16 element;
and where R is substituted, the substituent is selected from the group consisting of a halogen, nitro, cyano, alkoxy, carboxy, aryl, hydroxy, heterocyclic alkyl group, heterocyclic aryl group, a Group 4 metal, and a Group 13 through Group 16 element; and n is at least 8.

11. The transducer of claim 8, wherein R is Si.

12. The transducer of claim 8, wherein R is H.

13. A method of depositing layers in a magnetic recording transducer comprising
(i) providing a bottom surface;
(ii) depositing a liquid polymer precursor layer on said bottom surface; and
(iii) baking the polymer precursor layer at a temperature sufficient to convert said liquid polymer precursor to a ceramic material.

14. The method of claim 11, wherein the layer is selected from the group consisting of underlayer, planarization layer, read gap layer, write gap layer, adhesion layer and encapsulation layer.

15 The method of claim 11, wherein said layer is an underlayer.

16. The method of claim 11, wherein said layer is a planarization layer.

17. The method of claim 11, wherein said layer is an encapsulation layer.

18. The method of claim 11, wherein said layer is a first read gap layer.

19. The method of claim 11, wherein said layer is a second read gap layer.

20. The method of claim 11, wherein said layer is a write gap layer.

21. The method of claim 11, wherein said baking is carried out at a temperature of between about 20° C. to 1800° C., for a period of about 5 minutes to 60 hours.

22. The method of claim 11, wherein said baking is carried out at a temperature of between about 300° C. to 600° C. for a period of about 2 hours.

23. The method of claim 11, wherein said depositing is carried out by a method selected from the group consisting of spinning, dipping, spraying, or wiping.

24. The method of claim 11, wherein said depositing is carried out by spinning on said liquid polymer precursor.

25. The method of claim 11, wherein said depositing is carried out by spraying said liquid polymer precursor onto a spinning surface.

26. The method of claim 11, wherein said liquid polymer precursor is represented by the formula
[CR]ₙ
where R is the same or different and is selected from the group consisting of hydrogen, a saturated linear or branched-chain hydrocarbon containing 1-30 carbon atoms, an unsaturated ring hydrocarbon containing 5 to 14 carbon atoms in the ring, each of said ring carbon atoms in unsubstituted or substituted form, a halogen, a Group 4 metal, and a Group 13 through Group 16 element;
and where R is substituted, the substituent is selected from the group consisting of a halogen, nitro, cyano, alkoxy, carboxy, aryl, hydroxy, heterocyclic alkyl group, heterocyclic aryl group, a Group 4 metal, and a Group 13 through Group 16 element; and n is at least 8.

27. The method of claim 11, wherein R is Si.

28. The method of claim 11, wherein R is H.
